(19) United States
(12) Patent Application Publication
(10) Pub. No.: US 2004/0168187 A1
(43) Pub. Date: Aug. 26, 2004

(54) Talking remote control with display

(76) Inventor: Allen Chang, Tustin, CA (US)

Correspondence Address: Alexander Shvarts, FISH & NEAVE, 1251 Avenue of the Americas, New York, NY, 10020-1105, US

(21) Appl. No.: 10/701,296

(22) Filed: Nov. 3, 2003

Related U.S. Application Data
(63) Continuation of application No. 09/284,175, filed on May 28, 1999.
Application No. 09/284,175 is a 371 of international application No. PCT/US97/18187, filed on Oct. 8, 1997.
(60) Provisional application No. 60/027,951, filed on Oct. 8, 1996.

(51) Int. Cl. H04N 5/44; G06F 3/00; H04N 5/445; G06F 13/00

(52) U.S. Cl. 725/40; 348/734; 725/50

(57) ABSTRACT

A remote controller includes a display screen (12) and a speaker (14). The remote controller receives and stores transmitted television program information, preferably including an electronic program guide (EPG). Preferably the program information is transmitted over a wireless paging system (FIG. 6) at a preferred frequency of about 900 MHz. A microcontroller (46) in the controller includes a digital signal processor for sorting and storing the retrieved program information. In response to a viewer command input through a keypad (15) on the remote controller, the microcontroller selectively retrieves and displays at least a portion of the program information on the display screen of the remote controller. The display changes as the viewer changes channels or scrolls through the EPG. The remote controller also has a voice message function. When the voice message function is activated, the microcontroller retrieves and processes a voice message for announcement through the speaker. The voice message corresponds to the television program currently displayed on an associated television system or a selected program in the EPG.

### CROSS-REFERENCE TO RELATED APPLICATION

This application is a continuation of U.S. patent application Ser. No. 09/284,175, filed on Apr. 8, 1999, which is a U.S. National Stage of International Application No. PCT/US97/18187, filed on Oct. 8, 1997, which claims priority of U.S. Provisional Application No. 60/027,951 filed Oct. 8, 1996, the disclosure of which is incorporated fully herein by reference.

### BACKGROUND

A number of televisions and television control systems (e.g., cable and satellite set-top boxes, VCRs) are capable of providing television program information in an on-screen display format, that is, as text directly on the television screen. In this manner, the viewer is provided with information about a currently displayed program without having to resort to a printed television schedule. Also available are various types of on-screen electronic program guides (EPGs) which provide several days' worth of program information for a number of different channels and times on the television display at the viewer's request. The program information may include channel (local channel and/or station name), title and a brief summary, as well as an EPG. Generally, the program information data is embedded in the television signal at a remote service provider site and telecast along with the normally telecast television signal. The data is then received at the viewer's end, stripped from the television signal and formatted for on-screen display.

In general, an on-screen display is a textual or graphic overlay which covers at least a portion of the displayed program. EPGs are usually in a grid format, arranged by channel and time, which may take up the television display. The on-screen display format is also used for television and VCR initial set-up operations and for set-up of VCR timed recordings.

On-screen displays obscure the program currently being displayed to some extent. This can be especially inconvenient when several people are watching a television program and one person wishes to access program information, set up the VCR for recording, or otherwise invoke the on-screen display function.

It is therefor desirable to provide means for automatically informing the viewer of program or set-up information without obscuring the television display.

### SUMMARY

According to one embodiment of the invention, a remote controller having a display screen receives and stores transmitted television program information. Preferably the program information includes an electronic program guide (EPG). In response to a viewer command input through a keypad on the remote controller, the remote controller selectively retrieves and displays at least a portion of the program information on the display screen of the remote controller. The display changes as the viewer changes channels or scrolls through the EPG in order to provide program information about the currently selected program on an associated television or in the EPG.

The remote controller operates in a normal mode and a guide mode. In the normal mode, program information corresponds to the program displayed on the associated television system. In the guide mode, the viewer may scroll through program information for a number of currently telecast programs as well as programs to be telecast in the future. Due to the size limitations of the remote controller display screen, preferably guide modes are provided which include abbreviated program information in order to display program information for several programs to fit on the display screen at one time.

According to another embodiment, the program information is transmitted as voice data. Preferably the program information includes an EPG. In response to a viewer command, the microcontroller retrieves and processes a voice message for announcement through a speaker in the remote controller. The voice message corresponds to the television program currently displayed on the associated television system or a selected program in the EPG.

Preferably the program information is transmitted over a wireless paging system at a preferred frequency of about 900 MHz. The microcontroller includes a digital signal processor for sorting and storing the retrieved program information.

### BRIEF DESCRIPTION OF THE DRAWINGS

The features of a specific embodiment of the best mode contemplated of carrying out the invention are illustrated in the drawings in which:

FIG. 1 is a remote controller according to a preferred embodiment of the invention;

FIG. 2 is a schematic of the remote controller components;

FIG. 3 is a display screen on the remote controller displaying program information for a currently telecast television program;

FIG. 4 is a display screen on the remote controller displaying an electronic program guide (EPG) including currently telecast programs on several different channels (the NOW guide format);

FIG. 5 is a display screen on the remote controller displaying an EPG including the currently telecast program and programs to be telecast in the future on the channel currently tuned by the associated television system (the NEXT guide format);

FIG. 6 is a schematic of the data transmission system for the remote controller; and

FIG. 7 is a display screen on the remote controller displaying the currently selected device for control by the remote controller.

### DETAILED DESCRIPTION

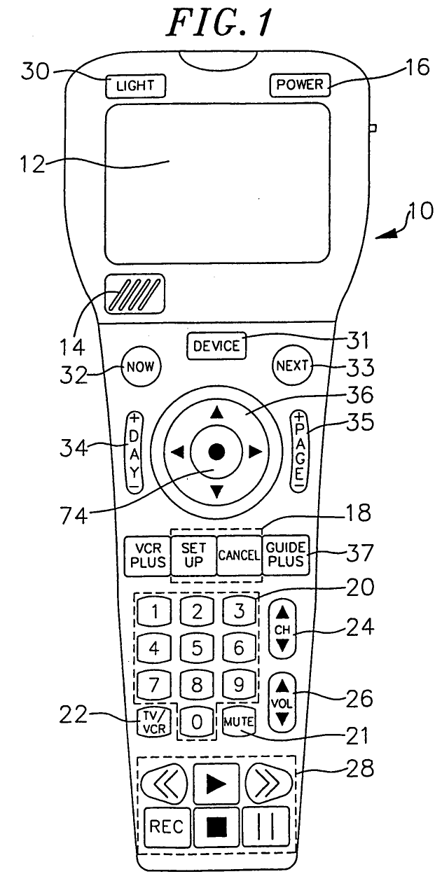

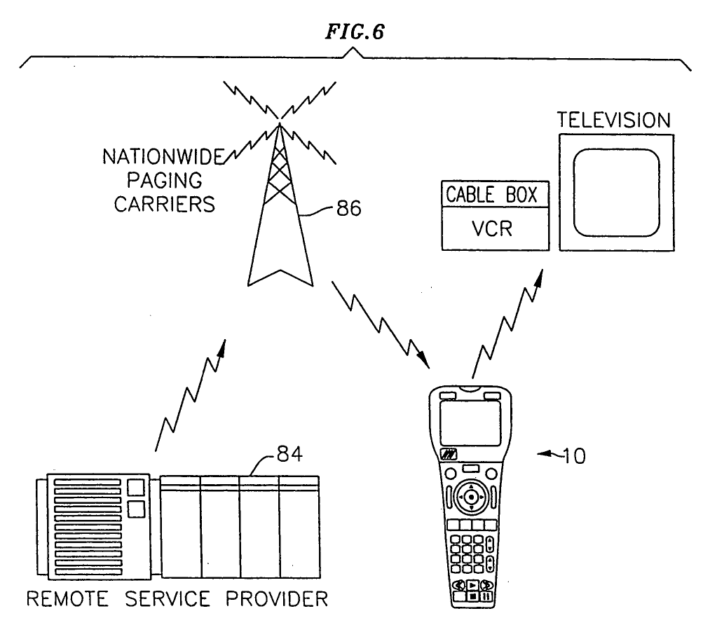

FIG. 1 illustrates a preferred embodiment of a remote controller 10 according to the invention. The remote controller 10 includes a display screen 12 to provide textual information regarding telecast television programs. The display screen 12 is capable of providing program information such as time, channel (local channel and/or station name), title, and a brief summary of the program. A speaker 14 is capable of outputting voice messages corresponding to the textual information on the display screen 12. The remote controller 10 receives regularly updated program information and other data from a remote service provider 84 (See FIG. 6). The remote controller 10 also has universal remote control capabilities which are enhanced by the display and audio features and data reception capabilities of the device.

The remote controller includes a keypad with various buttons for viewer input. A first set of buttons are common to universal remote controllers and perform the same functions, unless otherwise indicated. This first set of buttons includes POWER button 16, SETUP group buttons 18, numeric group button 20, MUTE button 21, TV/VCR button 22, CH UP/DOWN button 24, VOL UP/DOWN button 26, and RECORDER/PLAYER control group buttons 28. A second set of buttons are specific to the preferred embodiment and include LIGHT button 30, DEVICE button 31, NOW button 32, NEXT button 33, DAY button 34, PAGE button 35, CENTRAL CONTROL button 36, and GUIDE button 37. The functions of the second set buttons are described in detail below.

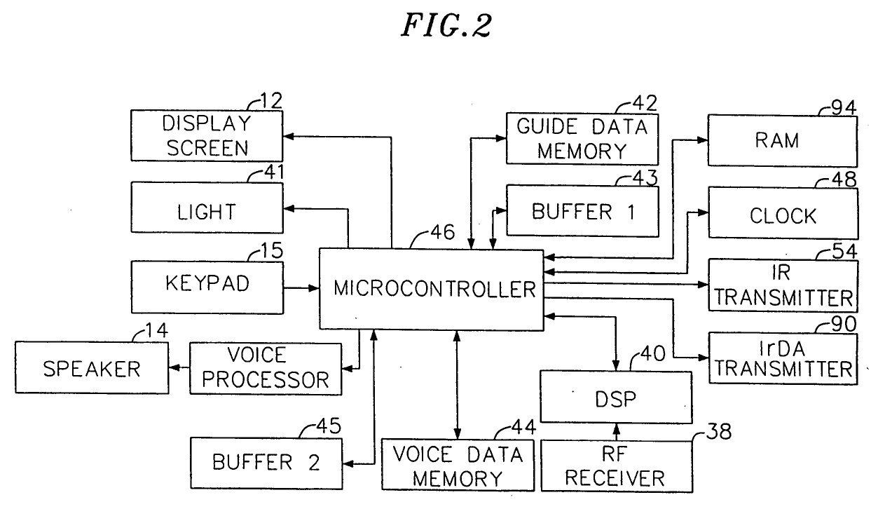

FIG. 2 is a schematic of the remote controller 10 components. RF receiver 38 receives regularly updated text and voice data from the remote service provider 84 (See FIG. 6). Preferably the data is transmitted by a nation-wide paging carrier to individual remote controllers 10 on a 900 MHz paging frequency. A digital signal processor (DSP) 40 reorganizes and stores the text data in a guide memory 42 and the voice data to a voice memory 44. In response to a viewer command, a microcontroller 46 retrieves the appropriate text data from the guide memory 42 and routes the data to display screen 12. The microcontroller 46 simultaneously retrieves corresponding voice data from the voice memory 44 and routes the voice data to voice processor 50 which processes the data into a voice message for announcement through speaker 14. The microcontroller 46 also controls a light 52 for illuminating the display screen 12 and an IR transmitter 54 for controlling other devices. An internal clock 48 is also provided.

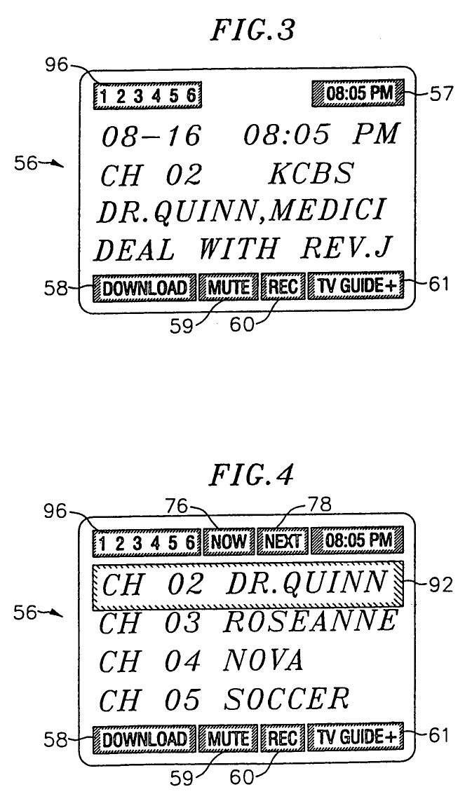

Display screen 12 is preferably a liquid crystal display (LCD) having a 4×16 character main display area 56 with a number of peripheral indicators-time indicator 57, DOWNLOAD indicator 58, MUTE indicator 59, RECORD indicator 60, GUIDE indicator 61, and DEVICE indicator 96. In a normal operating mode, the display screen displays information regarding a program currently displayed on an associated television screen or monitor. FIG. 3 illustrates an exemplary display. The program information can include date, time, channel, title and a brief description of the program to fully identify the program. The program information changes as the viewer changes the channel, thereby providing information about the new program.

Although the complete description may not fit into the 4×16 character window, the viewer can scroll to the “hidden” program information. To minimize data retrieval time during scrolling, guide memory buffer 43 contains program information for at least the currently displayed program.

A light 52 is provided to illuminate the display screen. Pressing LIGHT button 30 activates the light, preferably illuminating the display screen 12 for about 15 seconds.

The remote controller 10 also has electric program guide (EPG) capabilities. To access an EPG, the viewer presses GLIDE button 37. In this guide mode, GUIDE indicator 61 blinks. Preferably, EPG information is downloaded as text and voice data from the remote service provider on a daily basis and stored in guide memory 42 and voice memory 44, respectively. During the downloading, DOWNLOAD indicator 58 blinks, notifying the viewer that downloading is occurring.

The EPG is arranged in grid format with program information contained in individual cells arranged in rows according to channel and in columns according to time. The EPG is stored as a series of linked in individual “pages” of textual information arranged in the EPG grid format. According to one embodiment, only one cell or a portion thereof can be displayed on the display screen 12 at a time due to the size limitations.

Preferably, upon entering the guide mode, the cell of the EPG grid continuing program information for the currently displayed program is displayed. Since this cell contains the same information as displayed in the normal mode, there is no change in the display on display screen 12. However, the viewer is notified that the remote controller 10 is in the guide mode by the blinking of the GUIDE indicator 61. The viewer can navigate through the EPG grid using CENTRAL CONTROL button 68 in conjunction with DAY button 70 and PAGE button 72. The CENTRAL CONTROL button 68 is a circular button which includes a direction indicator arrows in each of four quadrants of the circle. By pressing the quadrant containing a particular indicator arrow, the viewer can scroll through the grid in the direction of the associated indicator arrow to display hidden text in an adjacent area of the guide. Pressing the DAY button 70 skips automatically to the next day in the guide, and pressing the PAGE button 72 skips automatically to the next page of the guide in a vertical orientation. Each cell includes at least program time, date, channel, and title to orient the viewer while scrolling through the guide (see FIG. 4).

Preferably, a center 74 button of the CENTRAL CONTROL button 68 controls two functions in the guide mode. Pressing the center button 74 once quickly activates a HOME function in which the microcontroller 46 automatically resets the display screen to the cell in the EPG correspond to the currently displayed program. Pressing the center button 74 for a longer period of time, e.g., two seconds, activates an “ENTER” function. The outcome of the ENTER function depends on the whether the selected cell, that is, the cell displayed on display screen 12, corresponds to a currently telecast program or to a program to be telecast in the future. If the cell corresponds to a currently telecast program, the microcontroller 46 automatically tunes the associated television (or television control system) to the channel carrying that program. Alternatively, if the cell corresponds to a program scheduled to be telecast in the future, the microcontroller automatically sets the VCR (if available) to record that program. Methods for automatically setting the VCR for timed recording are described in U.S. Pat. No. 5,353,121 owned by StarSight, Inc., herein incorporated by reference.

To maximize the information content of the limited LCD display, an alternate embodiment of the invention provides for two additional guide modes, designated “NOW” and “NEXT.” Corresponding indicator blocks 76, 78 are provided on the display screen 12 and corresponding guide buttons 80, 82 are provided on the remote controller 10. To enter either the NOW or NEXT guide mode, the corresponding button 80, 82 is pressed. When the remote controller 10 is in the NOW or NEXT guide mode, the corresponding indicator block 76, 78 blinks.

The NOW and NEXT guide modes provide abbreviated program information, one program per row of the (4×16) display screen 12, so that information for four programs can be displayed simultaneously. Preferably, the currently displayed program is the top listing upon entering the NOW or NEXT guide mode. Preferably, the selected program is highlighted by a cursor 92.

The NOW guide mode provides information for the currently telecast programs. An exemplary display for the NOW guide is shown in FIG. 4. Since all of the programs are currently being telecast, only the channel identification and program title are needed to adequately identify the programs; time and date are unnecessary.

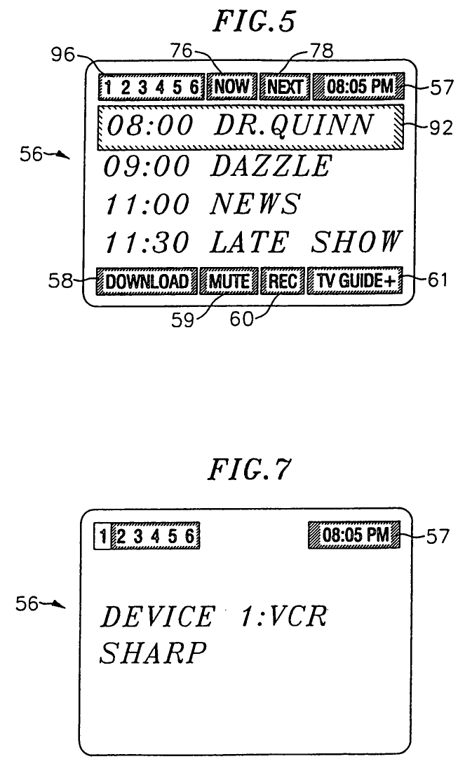

The NEXT guide mode provides information for the currently displayed programs and for programs to be telecast in the future on the channel currently tuned by the associated television system. An exemplary display for the NEXT guide is shown in FIG. 5. Since all of the programs are to be telecast on the same channel, and the shows are arranged in chronological order, only the program start time and program title are needed to adequately identify the programs; channel and date are unnecessary.

According to another preferred embodiment of the invention, microcontroller 46 controls speaker 14 to announce voice messages corresponding to the information displayed on display screen 12. Preferably, the voice message is announced upon changing the information on the display screen 12. For example, upon entering the screen shown in FIG. 3, either in the normal operating mode or guide modes, speaker 14 will announce a message such as, “Channel two, KCBS, Doctor Quinn, Medicine Woman.”

The voice message feature may be deactivated. When deactivated, the MUTE indicator 59 on the display screen 12 blinks. According to one embodiment, pressing MUTE button 21 deactivates the voice message feature. In an alternate embodiment, a switch 88 is provided on the side or back of the remote controller to (de)activate the voice message function. In this alternate embodiment, MUTE button 21 controls television muting.

FIG. 6 is a schematic of one embodiment of a data transmission system for the remote controller 10. A remote service provider 84 prepares the data to be sent to the individual remote controller units 10, including EPG and voice data. The remote service provider 84 then modems this information to nationwide paging carriers 86 for transmission to the individual remote controller units 10 along with the transmission of other paging information. The remote service provider 84 receives program information data daily and converts the information to EPG data and to voice data using known voice processing methods. Since data downloading is from a networked paging carrier, the download schedules can be fixed or flexible, depending on the paging carrier's capacity and the needs of the viewers. Preferably, the data is stored by the paging carriers 86 until a low traffic period, such as the middle of the night, and then transmitted to the individual remote control units 10, because immediate communication of the data is not important. Thus, the spare capacity of the paging system can be used to distribute the data utilized by the invention. Paging systems for downloading EPG data to individual units are described in patent application Ser. No. 08/369,525 filed Jan. 5, 1995 (VideoGuide, Inc.), which is hereby incorporated by reference.

Preferably, the remote controller 10 is compatible with Gemstar's VCR Plus+ system so that VCR Plus+ codes may also be downloaded simultaneously with the guide information.

According to a further embodiment, the paging system is used to provide additional services to the individual viewers. Sports and stock information may be downloaded to individual viewers on a subscription basis as well as personalized billing information. Clock data may be sent on a regular basis to update the internal clock 48 (see FIG. 2).

In a further embodiment, the remote controller 10 includes a high speed IrDA transmitter 90 for transmitting EPG information to other devices. IrDA transmitter is capable of sending guide information to a laser printer, for printing out the guide, or a personal computer, television or VCR for display of the EPG grid on the associated display screen. According to this embodiment, the EPG is displayed in the preset on-screen display format for that device. Preferably the EPG data contained in guide memory buffer 43 “is transmitted to the other devices.

In yet another embodiment, the remote controller operates as a universal remote for controlling several devices. Preferably the remote controller is capable of controlling six other devices. Individual control of these devices is enabled by entering the proper IR codes for each device in the remote controller 10 which are stored by microcontroller 46 in RAM 94 (FIG. 2). Also, at a user request, e.g., by telephone, the appropriate IR control codes for a particular device may be downloaded through the network paging system to that viewer's remote controller for automatic set-up of the remote controller 10 (See Appendix A for preferred transmission standards).

DEVICE indicator 96 includes six number indicators 97. The number indicator corresponding to the selected device will blink while that device is selected. According to one embodiment, upon pressing the DEVICE button 31 once within two seconds, the microcontroller 46 will control the display screen to display a description for selected device, in this example a Sharp brand VCR, and its device designation, “1,” as shown in FIG. 7. According to this embodiment, upon pressing the DEVICE button 31 twice within 2 seconds, the microcontroller 46 will select another device for control, moving sequentially through the number designations (I-6) for the available devices. Alternatively, the viewer may select another device by pressing the DEVICE button 31 and the number key (1-6) corresponding to the desired device designation.

The described embodiments of the invention are only considered to be preferred and illustrative of the inventive concept; the scope of the invention is not to be restricted to such embodiments. Various and numerous other arrangements may be devised by one skilled in the art without departing from the spirit and scope of this invention.

What is claimed is:

1. A remote controller for controlling a plurality of apparatus, comprising:
a display screen;
a receiver for receiving transmitted data representing a program guide containing a schedule of program listings wherein the listings include a plurality of program titles, the transmitted data further including voice data corresponding to the schedule of program listings in the program guide;
a memory for storing the received program guide data;
user input means for inputting user commands;
a microcontroller configured to retrieve a portion of the program guide data, including a portion of the schedule of program listings, from the memory in response to a first user command and display the selected portion of the program guide on the display screen, wherein the microcontroller is further configured to retrieve from the memory that portion of the voice data that corresponds to the retrieved portion of the schedule of program listings in the program guide displayed on the display screen, convert the voice data to voice messages, and output the voice messages through a speaker; and
a transmitter for transmitting signals to a selected one of the plurality of apparatus.

2. A television system comprising:
a source of data representing a program guide containing a schedule of program listings wherein the listings include a plurality of program titles;
a system transmitter for transmitting the program guide data;
a plurality of apparatus at a user site; and
a remote controller at the user site for selectively controlling the plurality of apparatus, comprising
a receiver for receiving the transmitted program guide data including voice data corresponding to the schedule of program listings in the program guide,
a memory for storing the program guide data,
a display screen,
user input means for inputting user commands,
a microcontroller configured to retrieve a selected portion of the program guide data, including a portion of the schedule of program listings, from the memory in response to a first user command and display the selected portion of the program guide on the display screen, wherein the microcontroller is further configured to retrieve from the memory that portion of the voice data that corresponds to the retrieved portion of the schedule of program listings in the program guide displayed on the display screen, convert the voice data to voice messages, and output the voice messages through a speaker, and
a remote controller transmitter for transmitting signals to a selected one of the plurality of apparatus.

3. The television system of claim 2, wherein the system transmitter is a pager carrier system and the receiver is a pager receiver.

4. The remote controller of claim 3, wherein the system transmitter transmits the program guide data at a frequency of about 900 Mhz.

5. The television system of claim 2, wherein the microcontroller is further configured to scroll the display on the display screen through different portions of the program guide in response to a second user command.

6. In a remote controller having a display screen, a method for navigating a program guide comprising information regarding a plurality of television programs comprising the steps of:
receiving a signal including data representative of the program guide guide containing a schedule of program listings, wherein the listings include a plurality of program titles and voice data corresponding to the schedule of program listings in the program guide;
storing the program guide and voice data in a memory;
selecting a program guide display in response to a user command;
retrieving a first portion of the program guide, including a first portion of the schedule of program listings, from the memory that includes information regarding a currently selected program broadcast on a currently selected channel;
displaying the first portion of the program guide on the display screen;
retrieving voice data that corresponds to the first portion of the schedule of program listings in the first portion of the program guide displayed on the display screen;
converting the voice data to a voice message;
announcing the voice message through a speaker;
selecting a second portion of the program guide in response to a user command;
retrieving the second portion of the program guide from the memory; and
displaying the second portion of the program guide on the display screen.

7. The method of claim 6, wherein the second portion of the program guide consists of currently broadcast programs.

8. The method of claim 6, wherein the second portion of the program guide consists of programs broadcast on the currently selected channel.

9. A remote controller for controlling a user terminal having a television tuner, comprising:
a display screen displaying a television program guide containing a schedule of television programs;
a receiver receiving transmitted data representing the program guide;
a memory storing the received program guide data;
user input means for inputting user commands;
a microcontroller configured to select one of the television programs on the display screen in response to a first user command, wherein the microcontroller determines whether the selected television program is currently being broadcast and wherein the microcontroller automatically tunes the television tuner to the selected television program in response to the first user command if the selected television program is currently being broadcast, and wherein the microcontroller is further configured to automatically program an associated VCR to record the selected television program in response to the first user command if the selected television program is scheduled to be broadcast in future; and
a transmitter coupled to the microcontroller for transmitting signals that tunes the television tuner or program the associated VCR;
wherein the microcontroller is configured to transmit the program guide data to the television tuner through the transmitter.

10. The remote controller of claim 10, wherein the television program guide includes the title of the television program.

11. The remote controller of claim 10, wherein the microcontroller further comprises a digital signal processor for sorting the program guide data and storing the program guide data in the memory.

12. The remote controller of claim 10, further comprising a speaker, wherein the transmitted program guide data includes voice data corresponding to the program guide, and wherein the microcontroller is further configured to retrieve from the memory voice data corresponding to the selected portion of the program guide displayed on the display screen, convert the voice data to voice messages, and announce the voice messages through the speaker.

13. The remote controller of claim 10, further comprising means for storing in the memory data representing textual information relating to the television tuner, and wherein the microcontroller is further configured to display textual information corresponding to a television tuner in response to a second user command.

14. The remote controller of claim 10, wherein the selected program listing is a current television program, and the microcontroller tunes the television to the channel carrying that program in response to the user command.

15. The remote controller of claim 10, wherein the selected program listing is a future television program, and the microcontroller sets the television tuner to record the future program in response to the user command.
